(19) United States
(12) Patent Application Publication
(10) Pub. No.: US 2005/0114275 A1
(43) Pub. Date: May 26, 2005

(54) Wireless display controller for inbound and outbound mailing and shipping system

(76) Inventors: Jerome Agnola, San Francisco, CA (US); Mark Ferraro, Hamden, CT (US)

Correspondence Address: PERMAN & GREEN, 425 POST ROAD, FAIRFIELD, CT, 06824, US

(21) Appl. No.: 10/768,766

(22) Filed: Jan. 30, 2004

Related U.S. Application Data
(60) Provisional application No. 60/469,978, filed on May 13, 2003.

(51) Int. Cl. G06F 17/60

(52) U.S. Cl. 705/401; 700/224; 705/410

(57) ABSTRACT

A mail processing system that includes a franking machine and at least one removable user interactive display. The display includes a wireless connection for wireless communication between the display and the franking machine when the display is physically disconnected from the franking machine.

### CROSS-REFERENCE TO RELATED APPLICATIONS

This application claims the benefit of U.S. Provisional Application No. 60/469,978, filed May 13, 2003.

### BACKGROUND OF THE INVENTION

1. Field of the Invention

The present invention generally relates to mail processing systems and in particular to a multi-use wireless display/control panel for a mail processing system.

2. Brief Description of Related Developments

Mail handling systems for printing postal indicia on mail items are known. Franking machines can include a printing device for printing a franking impression including postal indicia on a mail piece as well as accounting and control unit functions.

Postage meters are generally stand-alone devices that print postage indicia on mail items such as for example envelopes or labels. The meters are typically at a single user location and provide metering for that location. Postage meters and franking machines can include control panels and displays that allow a user to access the functions of each device and the system.

A postage metering system can also include other functionalities for the processing of mail items, including inbound, outbound mail, parcel and information flow.

A secure cryptographic vault device, also known as a postal security device (PSD), is used for securely storing data, such as amounts of postage. The cryptographic vault device can securely store data so that the data cannot be tampered with without destroying the data. The data stored in a cryptographic vault is secured against physical attacks on the hardware of the cryptographic vault device and against software intrusions.

The cryptographic vault device is integrated in turnkey postage dispensing systems, such as postage meters. Other devices integrated with the cryptographic vault device can include, for example, a printer, a scale, and an envelope feeder mechanism. The turnkey system can also include a personal computer, server or workstation directly coupled to the cryptographic vault device. Direct access to the cryptographic vault device is only from some of the integrated components of the postage dispensing system. Therefore, the use of the cryptographic vault device is limited to the functions built into the integrated postage dispensing system. In order to provide customized access to the cryptographic vault device, a user would have to acquire a turnkey system, which includes predefined devices and software, and then customize the turnkey system to meet business requirements.

Value metering devices are devices which in their most basic form meter value. These devices take various forms such as, for example, postage meters (i.e. franking machines), various kinds of vending machines (i.e. lottery vending machines), tax stamp machines, various kinds of ticket dispensing machines, etc. Of these various devices, postage meters are one form of a value metering device that dispense value in the form of postage, e.g. postage indicia, basically either as a stand-alone type postage meter or as part of a mailing system. The stand-alone type postage meter is basically a postage meter having both its entire accounting system and security system positioned in a single secure housing, the accounting system being mechanically coupled to the printing mechanism which prints the postage related indicia.

In addition to the stand-alone type systems as described above there are mailing systems which are basically formed of a mailing machine (i.e. a machine that can perform different mailing related functions (e.g. feeding, stacking, separating, sealing of envelopes, etc.) on which a postage meter is securely mounted. The postage meter is typically located in a securely sealed housing, which contains the accounting and printing mechanisms. In the past few years both ink jet printing technology and smart card technology (i.e. smart cards used for securely housing the accounting circuitry of the postage meter) have been employed in these postage meters. The mailing machine systems including an electronic postage meter have enabled the users of such equipment to customize the exact type of mailing system they require by designing the overall mailing system in a modular fashion. One is able to set up a mailing system that will include individually removably mounted modules that can be added to or removed from the mailing system. For example, if one had a modular mailing system without an envelope stacker, one could add such a module to their system, and thereby have a mailing system that is able to stack envelopes once the postage has been placed on envelopes that are fed into the system. If the stacker module required repair, the stacker could easily be removed for repair since it is but one module within a modular system. Features such as inserters, feeders/separators, sealers, scales, moisteners, addressers, stackers, etc. can be added for use with a postage meter to form different types of mailing systems.

### SUMMARY OF THE INVENTION

The present invention is directed to a mail processing system. In one embodiment the system comprises a franking machine and at least one removable user interactive display coupled to the franking machine. The removable display includes a wireless connection for wireless communication between the removable display and the franking machine when the removable display is disconnected from the franking machine.

### BRIEF DESCRIPTION OF THE DRAWINGS

The foregoing aspects and other features of the present invention are explained in the following description, taken in connection with the accompanying drawings, wherein:

FIG. 1 is a block diagram of one embodiment of a system incorporating features of the present invention.

FIG. 2 is a perspective view of one embodiment of a mail system incorporating features of the present invention.

FIG. 3 is a schematic diagram of one embodiment of a system incorporating features of the present invention.

FIG. 4 is a block diagram of one embodiment of an apparatus that may be used to practice the present invention.

### DETAILED DESCRIPTION OF THE PREFERRED EMBODIMENT(S)

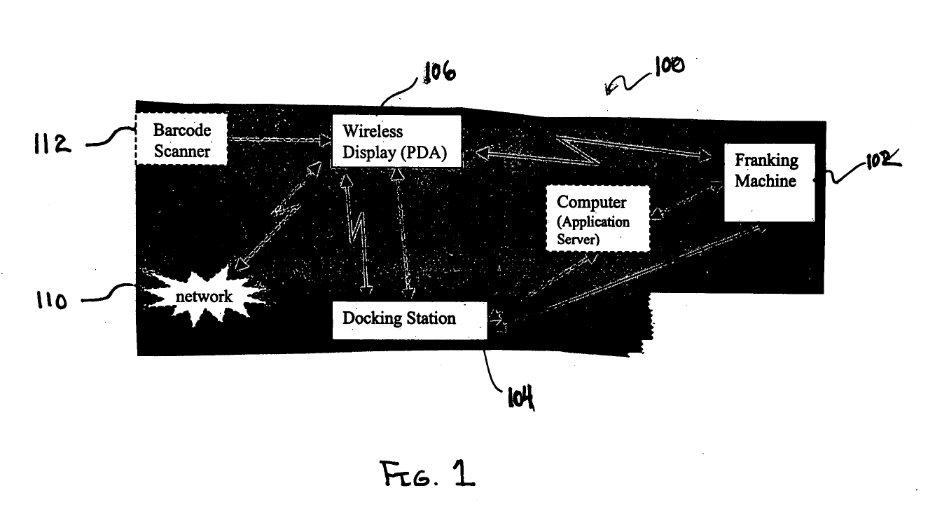

Referring to FIG. 1, a block diagram of a system 100 incorporating features of the present invention is illustrated. Although the present invention will be described with reference to the embodiments shown in the drawings, it should be understood that the present invention can be embodied in many alternate forms of embodiments. In addition, any suitable size, shape or type of elements or materials could be used.

FIG. 1 illustrates one embodiment of a mail management system 100 incorporating features of the present invention. The present invention generally allows a user to have unfettered physical mobility in a mailroom and allows multiple activities to take place relating to the processing of mail. A franking machine 102 is coupled to a docking station 104 and a wireless display or controller 106. The wireless display or controller 106 is generally a user interactive device, such as for example a graphical user interface (“GUI”), that allows a user to view, access and manage the various functionalities of the franking machine 102 and the mail management system 100. In one embodiment the wireless display 106 can comprise a computing device such as for example a personal computer (“PC”) or a personal digital assistant (“PDA”). The franking machine could also be connected to a computer 108, or application server. The wireless display 106, docking station 104 and computer 108 could be incorporated into the franking machine 102 or a PC terminal.

In one embodiment, the wireless display 106 connects to the PC or directly to the franking machine 102 via a hardwire connection. The wireless display 106 could also be coupled to the franking machine 102 via a wireless connection, such as for example radio frequency (“RF”), infrared (“IF”) or ultrasound. Once the wireless display 106 is connected to the franking machine 102, the wireless display 106 allows a user to access the information, applications and services located but not limited to the computer 108, franking machine 102, internet, intranet or PDA, for example. In one embodiment the wireless display 106 can communicate with a network 110, such as for example the internet, and send and retrieve data and other information for the mail processing functions.

The docking station 104 provides a physical connection to the computer 108 or the franking machine 102, and can recharge a battery of the wireless display 106. In one embodiment, the docking station can be located in the physical proximity of the franking machine 102 to provide the most ergonomic access for the mailroom operator.

The wireless display 106 of FIG. 1 becomes an extension of the mail management system and can be used to process inbound and outbound mail flow.

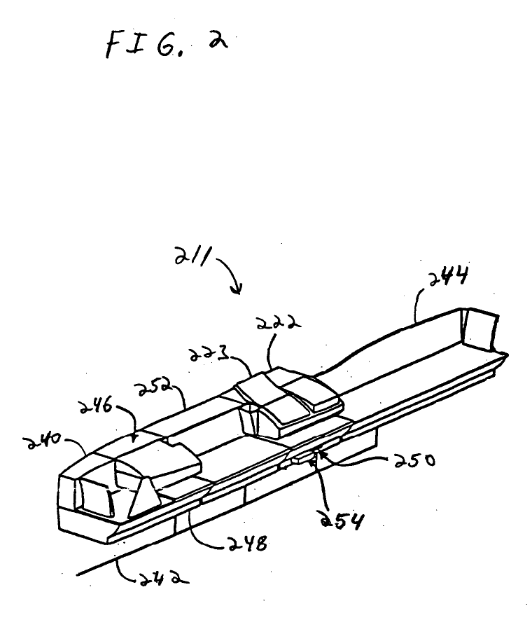

Referring to FIG. 2, in general, the franking system 211 comprises a device for printing postage on letters. In an alternate embodiment, the franking system 211 can comprise any suitable device for providing a postal indicium on a mailpiece. Furthermore, the franking system 211 can be a modular device in that the franking system 211 is designed so that operating features can optionally be added or removed from the franking system 211. These features can include for example, feeders, stackers, separators, sealers, scanning devices, accounting devices, weight scales and inbound and outbound mail processing systems.

Referring to FIG. 2, in one embodiment, the franking system 211 can include an input device 223, and peripheral devices systems. The input device 223 can include a display or touch screen, a keyboard and a main computer for entering or updating system data, such as entering an authorization code. Other input devices 223 can include a microphone, a CD or a DVD reader, other storage devices and readers, scanners, and data input devices, including voice, audio and visual input devices. Other input means or devices could include network connections such as the internet or an intranet, without departing from the broader aspects of the present invention.

Each peripheral device shown in FIG. 2 generally comprises a device for implementing letter flow through the franking system 211. The peripheral devices that can be attached to the franking system 211 can include a bus system 242 for connecting peripheral devices to a franking module 222, a static weighing scale 246, a stand 248 for the static weighing scale 246, the rate package card 250, and a dynamic scale 252 for determining an accurate weight of mail pieces to calculate the different postage to be applied. The franking system can also include the postal security device 254, which includes postage data and postal statistics data.

Network functionality is achieved by having a network controller that physically attaches a franking machine to the network and protocol stack software that handles the lower layers of the required network communications protocols. On top of these protocols, there are several application protocols.

A franking machine or system incorporating features of the present invention generally includes a network controller and protocol stack software that allows the machine to communicate to any other system connected to a LAN or to any system connected to the internet if the LAN provides a gateway to the internet. The communication protocol to the peer system can be any protocol on top of the network protocol stack, including the protocol utilized in conjunction with a web browser in case the franking machine contains an optional web browser.

Independent of the existence of a web browser in the franking system, the system can include one or several URLs identifying one or several servers that are contacted for various purposes.

In one embodiment the wireless display/controller 106 of FIG. 1 does not include a separate keyboard or mouse for data input. Rather, data can be entered into the wireless display/controller 106 via a touch screen, a pen or a voice interface device, for example. In alternate embodiments any suitable type of input means can be used to input commands or data into the wireless display/controller 106.

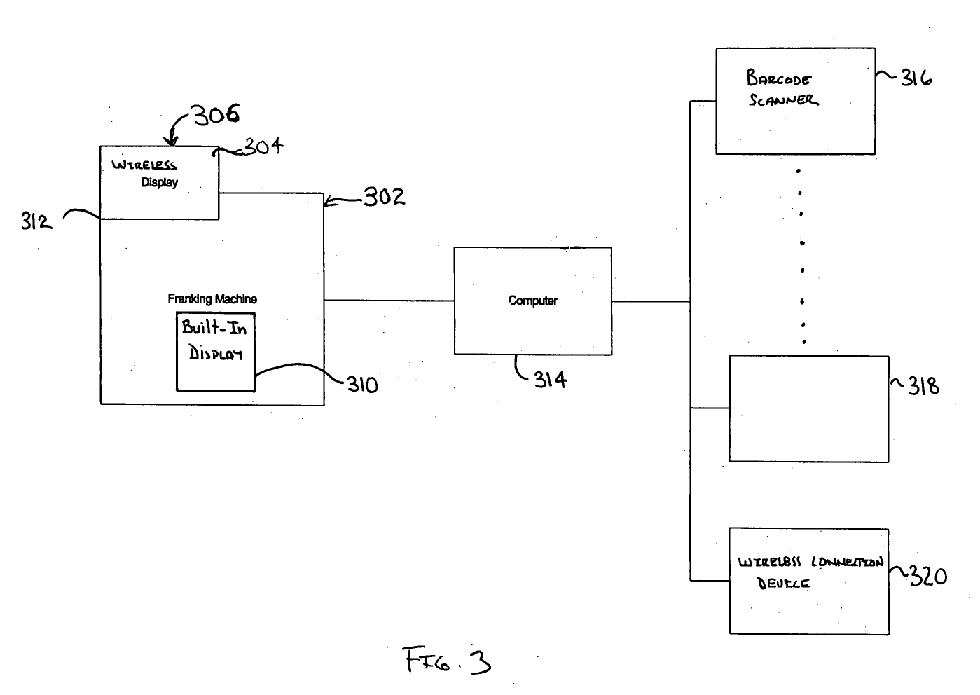

Referring for example to FIG. 3, the display portion 304 of the wireless display/controller 306 could be large enough to allow an HTML page to be displayed. In this embodiment, the display of the franking machine 302 is formatted into an HTML page that can be displayed. User accessibility can be enhanced by using a larger screen and speech recognition command techniques.

The present invention generally allows for multitasking in a mailroom. When the wireless display/controller 306 of FIG. 3 is removed from its cradle, also referred to as docking station 312, a built-in display or controller (GUI) 310 of the mail machine 302 becomes active. The operator can run mail on the postage machine 302 using the controller, while another operator can use the wireless display/controller 306 to perform other tasks related to mail processing and management in or around the mailroom. These other tasks can include, for example, connecting, either directly or through a wireless connection device 320 of the computer 314, the wireless display/controller 306 to a barcode scanner and scanning incoming packages or mail. The display/controller 306 could connect to the scanner via, for example, a USB port. In alternative embodiments, any suitable connection mechanism can be used. The barcode scanning could include one and two-dimensional scanning and optical character recognition (“OCR”). The display/controller 306 could also be used to meter outgoing mail or arrange for the shipment of packages via other commercial carriers, such as for example, Fed Ex and UPS.

In one embodiment the wireless display/controller 306 can be used in conjunction with mail delivery to obtain a mail recipient's signature on a screen 304 of the display while also being used to scan the barcode of the item or package being delivered. In this embodiment the wireless display/controller 306 is adapted to be disconnected or removed from the franking machine 302 or controller 306 and used as a stand-alone device in connection with mail delivery. This could occur away from the mail-processing site, at for example, the actual delivery location. The data in connection with the delivery, such as for example the parcel number, address information and a signature of the recipient could be acquired by the controller 306 and stored within the controller 306. The data and information could be stored and downloaded to the franking machine 302 or mail processing system 300 when the controller 306 is re-connected with the franking machine 302. In one embodiment, the acquired data and information could be transferred to the franking machine 302 via a modem, an RF link or other form of remote communication. In one embodiment the controller 306 is adapted to connect to the internet, even when it is remote from the franking machine 302, and transfer the information via an Internet Service Provider (“ISP”) or a Virtual Private Network (“VPN”) or other such internet related gateway or communication pathway.

In one embodiment the wireless display/controller 306 can be connected to a network or other computer to download or upload information, such as for example rate data, mailing or shipping data, or to reset postage value or replenish postage to the franking machine 302 or computer 314. Any suitable connection means can be used including, for example, a telephone jack or modem, a network connection (TCP/IP, LAN) or a wireless connection.

In one embodiment, the wireless display/controller 306 could be uncoupled from the franking machine 302 and used to obtain or replenish funds needed to print potage indicia. For example, the controller 306 could be used to connect, via a telemeter setting (“TMS”) process with the postal indicia provider. After an exchange of information and data over a cryptographically secure communication link, the controller 306 can be updated with a new value of funds for postal indicia. When the controller 306 is re-coupled to the franking machine 302, the funds data and information can be transferred to the franking machine 302. In this manner, the franking machine can continue to process and mark mail pieces with-postal indicia in a relatively continuous and seamless manner while the accounting and funds information is updated.

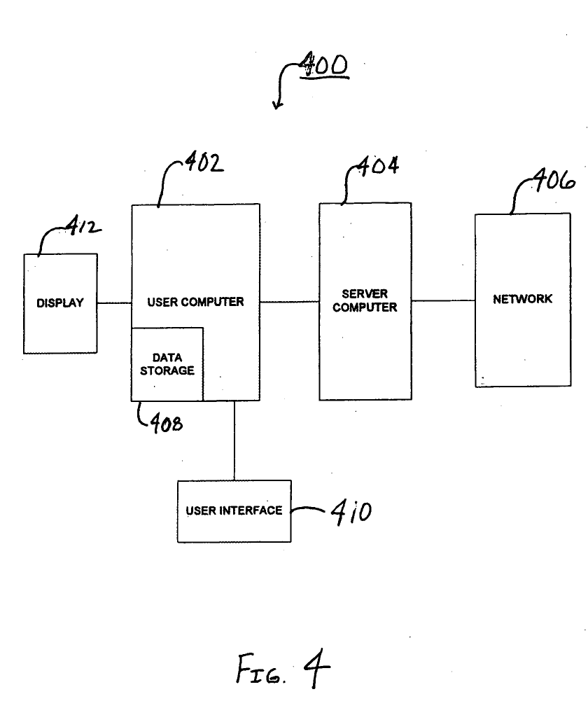

The present invention may also include software and computer programs incorporating the process steps and instructions described above that are executed in different computers. In the preferred embodiment, the computers are connected to the Internet. FIG. 4 is a block diagram of one embodiment of a typical apparatus incorporating features of the present invention that may be used to practice the present invention. As shown, a computer system 400 may be linked to another computer system 402, such that the computers 400 and 402 are capable of sending information to each other and receiving information from each other. In one embodiment, computer system 402 could include a server computer adapted to communicate with a network 404, such as for example, the Internet. Computer systems 400 and 402 can be linked together in any conventional manner including a modem, hard wire connection, or fiber optic link. Generally, information can be made available to both computer systems 400 and 402 using a communication protocol typically sent over a communication channel or through a dial-up connection on ISDN line. Computers 400 and 402 are generally adapted to utilize program storage devices embodying machine readable program source code which is adapted to cause the computers 400 and 402 to perform the method steps of the present invention. The program storage devices incorporating features of the present invention may be devised, made and used as a component of a machine utilizing optics, magnetic properties and/or electronics to perform the procedures and methods of the present invention. In alternate embodiments, the program storage devices may include magnetic media such as a diskette or computer hard drive, which is readable and executable by a computer. In other alternate embodiments, the program storage devices could include optical disks, read-only-memory (“ROM”) floppy disks and semiconductor materials and chips.

Computer systems 400 and 402 may also include a microprocessor for executing stored programs. Computer 400 may include a data storage device 406 on its program storage device for the storage of information and data. The computer program or software incorporating the processes and method steps incorporating features of the present invention may be stored in one or more computers 400 and 402 on an otherwise conventional program storage device. In one embodiment, computers 400 and 402 may include a user interface 407, and a display interface 408 from which features of the present invention can be accessed. The user interface 407 and the display interface 408 can be adapted to allow the input of queries and commands to the system, as well as present the results of the commands and queries.

The disclosed embodiments provide a wireless display/control panel that allows full mobility as well as multitasking in the mailroom, and becomes an extension of the mail management system by processing inbound and outbound mail, parcel and information flow, and other mail processing activities. The wireless display/control panel allows-an operator to run mail on the postage machine while another operator uses the wireless display to perform other tasks and operate other mail processing devices.

It should be understood that the foregoing description is only illustrative of the invention. Various alternatives and modifications can be devised by those skilled in the art without departing from the invention. Accordingly, the present invention is intended to embrace all such alternatives, modifications and variances which fall within the scope of the appended claims.

1. A mail processing system comprising:
a franking/postage machine;
at least one removable user interactive display coupled to the franking machine, then at least one removable display including a wireless connection for wireless communication between the removable display and the franking machine when the removable display is physically disconnected from the franking machine.

2. The system of claim 1 wherein the franking machine includes a second graphical user interface that is activated when the at least one removable display is in an undocked operating mode.

3. The system of claim 2 wherein the at least one removable display comprises a personal digital assistant.

4. A method for managing mail processing activities in a mailroom comprising:
removing a portable display of the franking machine from the franking machine;
activating a second display associated with the franking machine;
using the portable display to operate another function in the mailroom related to the mail processing activities other than the franking machine, while the franking machine is franking mail pieces.

5. The method of claim 4 further comprising using the portable display to scanning incoming packages and mail for identifier information.

6. The method of claim 4 further comprising using the portable display to meter outgoing mail.

7. The method of claim 4 further comprising arranging for a shipment of mailpieces via a commercial carrier using the portable display.

8. The method of claim 4 further comprising replenishing funds for the franking machine to print postal indicia by establishing a telemeter setting link between the portable display and a funds provider; transferring data related to the funds to the portable display; and transferring the data related to the funds from the portable display to the franking machine.

9. The method of claim 8 wherein the information related to the funds is transferred from the portable display to the franking machine when the portable display is reinserted into the franking machine.

10. The method of claim 8 wherein the information related to the funds is transferred from the portable display to the franking machine over a wireless communication link.

11. A computer program product comprising:
a computer useable medium having a computer readable code means embodied therein for causing a computer to manage multiple activities in a mailroom by using a portable display of a franking machine to operate other mail processing devices, the computer readable code means in the computer program product comprising:
computer readable program code means for causing a computer to activate a second display of the franking machine when the portable display is removed from the franking machine;
computer readable program code means for causing a computer to maintain a wireless communication connection between the portable display, the franking machine and other mail processing devices in the mailroom; and
computer readable program code means for causing a computer to enable the portable display to interface with and operate the other mail processing devices in the mailroom while the franking machine is franking mail pieces.
